(19) United States
(12) Patent Application Publication
(10) Pub. No.: US 2013/0141241 A1
(43) Pub. Date: Jun. 6, 2013

(54) RADIO FREQUENCY IDENTIFICATION BOOK MANAGEMENT SECURITY GATE

(71) Applicant: HORNG-JI CHEN, Hsinchu (TW)

(72) Inventor: HORNG-JI CHEN, Hsinchu (TW)

(73) Assignee: ClarIDy Solutions, Inc., Hsinchu City (TW)

(21) Appl. No.: 13/662,725

(22) Filed: Oct. 29, 2012

(30) Foreign Application Priority Data
Dec. 5, 2011 (TW) 100144692

(51) Int. Cl. G08B 13/14

(52) U.S. Cl. 340/572.1

(57) ABSTRACT

At least one omni-directional antenna and at least one directional antenna are both disposed inside the RFID book management security gate, in which the omni-directional antenna can broaden a detection angle and reduce leaky wave of an electromagnetic wave in the library; and the directional antenna strengthens the detection of the case that a book or reference material is grasped, carried under the arm or attached to the body, so as to achieve an objective of effective and security management for the book or reference material. When a user carries the reserved book or reference material through the security gate, an RFID tag on the book or reference material can be effectively detected, which can avoid that the book or reference material without a borrowing procedure is furtively taken away.

### BACKGROUND OF THE INVENTION

1. Field of Invention

The present invention applies Radio Frequency Identification (RFID) technique to a security gate for book management operation, so as to perform control and inspection at an exit of a library. At least one omni-directional antenna and at least one directional antenna are disposed inside the RFID book management security gate to effectively detect an RFID tag on each book or reference material when a user carries the reserved book or reference material through the security gate, which can avoid that the book or reference material without a borrowing procedure is furtively taken away. Moreover, the leaky wave of the electromagnetic wave to the surrounding is decreased, and misjudgment for books still in the library is reduced. Furthermore, in combination with a human body sensor, the power consumption is reduced, the correctness of system functions is improved, and it is convenient for automatically performing effective management operation of security control for the book or reference material.

2. Related Art

An RFID system basically includes an RFID tag, an RFID reader and an application system. An operating frequency used by the RFID includes a Low Frequency (LF, 134 KHz generally), a High Frequency (HF, 13.56 MHz generally), an Ultra-High Frequency (UHF, 860-960 MHz generally) and a microwave (2.4 GHz generally). A passive RFID tag does not have a battery, an internal analogue circuit of which converts an electromagnetic wave from the reader into electric energy for use. A memory in the RFID tag can store data, and may be classified into a read-only memory (ROM), a write-once-read-many memory (WORM), or a rewritable memory (such as EEPROM) according to design and processes. An HF RFID tag commonly available in the market has a Unique ID (UID) locked up when leaving the factory. In a new UHF RFID tag available in the market, if the tag conforms to a communication protocol of an Electronic Product Code (EPC), in addition to a chip manufacturer code and chip type data on a Tag ID (TID), a set of chip serial numbers also exists on the TID, a capacity of which varies from 32 bits to 64 bits according to a chip type of the manufacturer. The application system may use the related UID or the chip serial numbers according to the requirements in use for anti-counterfeit processing. An RFID reader supplies power to a passive RFID tag for operation, which is named “RFID reader”, but actually has functions of reading and writing data in the memory of the RFID tag. Only when the operating frequency of the RFID system is the same as that of the communication protocol, the RFID system can be normally used.

As for a security code for control of borrowing and returning books or reference materials, the RFID tag may use Electronic Article Surveillance (EAS), a Product Status Flag (PSF) or a specific memory in the RFID tag as the security code, so as to record the state control of the borrowing and the returning.

The book or reference material can be hold in a single hand, grasped with a single arm, grasped with both arms, carried under the arm, attached to the body, put in a knapsack, carried in a handbag, or pulled in a draw-bar box by a user in many ways, and the human body usually affects a reading rate of the RFID tag.

The conventional HF RFID book management security gate adopts a coil to generate a magnetic field, so as to sense the HF RFID tag on the book or reference material. The strength of the magnetic field is in a reverse ratio to a cube of the distance, so a common defect of the HF RFID book management security gate is the insufficient sensing range.

The conventional UHF RFID book management security gate merely adopts a directional antenna, in which multiple directional antennas arranged in a line or staggered left and right are required, so as to reduce a detection dead zone of the security gate. However, a reading range of the directional antenna is wide, so generally, the RFID tag is read even if the book or reference material is 3, 4 meters away or farther from the UHF RFID book management security gate, which usually results in that the book or reference material is detected without completing the borrowing procedure, and then a misjudgment is generated. When the RF output power is reduced to shorten the reading distance, the detection and reading rate is decreased, so it is difficult to detect the case that the book or reference material is grasped, carried under the arm or attached to the body. If the antenna angle is adjusted toward the outside of the library, so as to shorten the reading distance inside the library, it is difficult to detect the case that the book or reference material is grasped to the chest.

Another manner is that an omni-directional antenna is merely used, which is generally a cylindrical radiating antenna formed by a dipole antenna and a dipole array antenna, or a shelf antenna, and has a cylindrical and symmetrical radiation field. If the antenna is close to the security gate in height, the antennas are put in parallel; and if the antenna is not long enough, the antennas are staggered up and down. The omni-directional antenna detects and senses in a wide range, but the sensing distance thereof is short as the energy is not focused, so it is difficult to detect the case that the book or reference material is grasped, carried under the arm or attached to the body.

The conventional RFID book management security gate is disposed with a photoelectric sensor, so as to count the number of persons passing through the security gate. In a normal operation case, the RFID reader of the RFID book management security gate continuously switches the antenna for detection. However, even if nobody is around the security gate, the RFID reader still detects continuously, resulting in unnecessary energy consumption.

### SUMMARY OF THE INVENTION

To solve the above problems, the present invention provides an RFID book management security gate, so as to control and inspect at an exit of a library. At least one omni-directional antenna and at least one directional antenna are disposed inside the RFID book management security gate, so as to effectively detect an RFID book tag on each book or reference material when a user carries the reserved book or reference material through the security gate, which can avoid that the book or reference material without a borrowing procedure is furtively taken away. Moreover, the leaky wave of the electromagnetic wave to the surrounding is decreased, and misjudgment for books still in the library is reduced. Furthermore, in combination with a human body sensor, the power consumption is reduced, the correctness of system functions is improved, and it is convenient for automatically performing effective management operation of security control for the book or reference material.

To achieve the above objectives, the present invention provides an RFID book management security gate, which is applicable to a security gate for RFID book management operation and a book or reference material with RFID technologies, which comprises:
a security gate;
at least one RFID tag, in which an internal memory of the RFID tag stores a UID and a security code, and the RFID tag is attached to the book or reference material, so as to identify the book or reference material, and a borrowing and returning state thereof;
at least one omni-directional RFID reader antenna, disposed inside the security gate, and used to sense the RFID tag on the book or reference material and transmit a signal to an RFID reader;
at least one directional RFID reader antenna, disposed inside the security gate, and used to sense the RFID tag on the book or reference material and transmit a signal to an RFID reader;
at least one sensor, disposed on the security gate, and used to detect persons passing through the security gate, so as to perform management operation of the security gate; and
at least one prompt device, disposed on the security gate, and used to prompt that a book or reference material without a borrowing procedure is carried out of the security gate, so as to facilitate management.

Preferably, the RFID reader omni-directional antenna is one of a dipole antenna, a dipole array antenna, a shelf antenna and a chip antenna.

Preferably, the RFID reader directional antenna is one of a micro strip antenna, a patch antenna, a circular polarization antenna, a duplex polarization antenna, a linear polarization antenna, a linear polarization array antenna, a slot antenna, and a fractal antenna.

Preferably, the RFID tag is a UHF RFID tag.

Preferably, the RFID reader antenna is electrically connected to a built-in RFID reader, or is externally connected to an RFID reader through an RF coaxial cable, so as to read and write the RFID tag, and the book or reference material is a book, a document or an audio/video multimedia.

Preferably, the security gate basically comprises an outer lateral plate, an inner lateral plate, a front lateral cylinder, a rear lateral cylinder, a top cover, a base seat, and a controller, in which the outer lateral plate comprises a conductive metal material, so as to provide a shielding effect and reduce leaky wave of an electromagnetic wave; and the inner lateral plate is made of a non-metal material, so that the RFID antenna transmits and receives the electromagnetic wave, and reads the RFID tag, and the non-metal material comprises plastic, wood, paper, ceramic or glass.

Preferably, the controller is used to manage and control the sensor and the prompt device.

Preferably, the sensor is a human body sensor, and used to detect a case that nobody is around the security gate, thereby reducing detection times of the RFID reader and then achieving an energy-saving and carbon-reduction effect.

Preferably, the sensor is a photoelectric sensor, and used to detect times of persons passing through the security gate, and make statistical analysis on the use.

Preferably, the prompt device is an audio device, and used to generate a warning sound, so as to remind a user to transact a borrowing procedure for the un-borrowed book or reference material, and remind librarians to handle the situation.

Preferably, the prompt device is a light device, and used to generate warning light, so as to prompt a user to transact a borrowing procedure for the book or reference material without a borrowing procedure, and prompt librarians to handle the situation.

To describe the present invention in further detail, the drawings, embodiments and the present invention are specifically illustrated in the following for benefiting the examination by the examiners.

### BRIEF DESCRIPTION OF THE DRAWINGS

The present invention will become more fully understood from the detailed description given herein below for illustration only, and thus are not limitative of the present invention, and wherein:

FIG. 1A and FIG. 1B are respectively a schematic oblique view and a schematic cross-sectional view of an RFID book management security gate according to the present invention; and

FIG. 2A and FIG. 2B are respectively a schematic top view and a schematic side view of a top cover of an RFID book management security gate according to the present invention.

### DETAILED DESCRIPTION OF THE INVENTION

A specific structure of the present invention is described in the following with reference to the drawings as well as a connection relation thereof, for ease of understanding by the examiners.

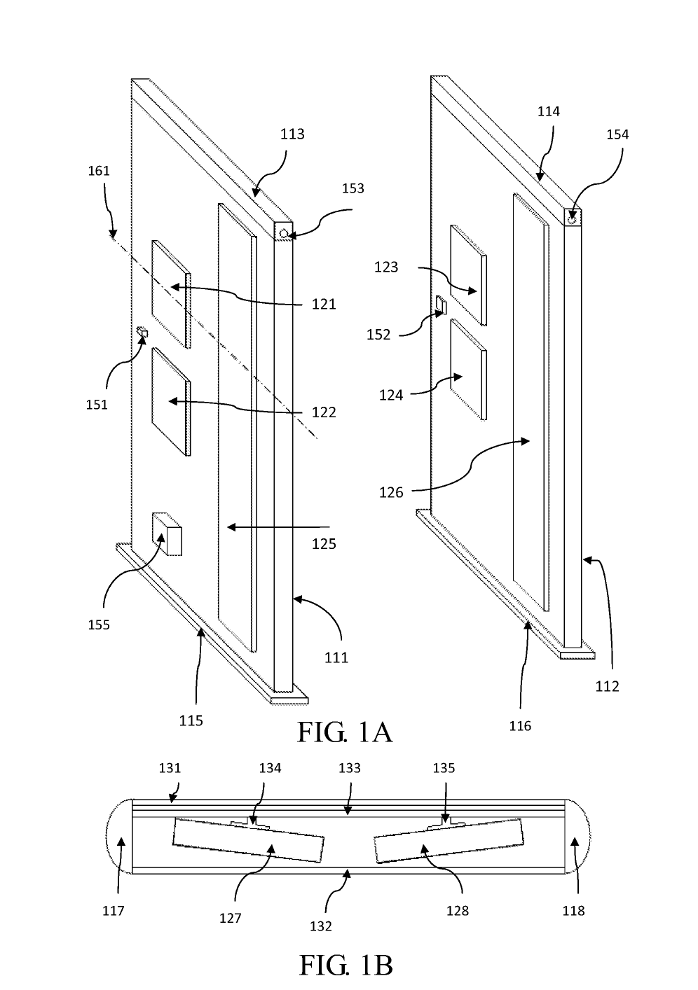

FIG. 1A and FIG. 1B are respectively a schematic oblique view and a schematic cross-sectional view of an RFID book management security gate according to the present invention, in which a cross section in FIG. 1B is shown along a horizontal section line 161. Each book or reference material, including a book or an audio/video multimedia, need to be attached with an RFID tag, and the RFID tag includes an UID and a security code therein. The UID is used to correspond to each book or reference material, and the security code is used to set a not-borrowing or a borrowing state. When the RFID book management security gate detects that the security code of the RFID tag on the book or reference material is in a not-borrowing state, a prompt device (not shown) is activated, so as to remind a user to transact a normal borrowing procedure and remind librarians to handle the situation. The present invention especially illustrates the application of UHF RFID technologies, including a UHF RFID tag, a UHF RFID reader and an antenna. The RFID book management security gate with a single passage has two security gates 111 and 112. For ease of description, a section between the two security gates 111 and 112 is referenced as an inner side, and conversely there is an outer side. A section close to the inside of a control area is referred to as a front side, and a section close to the outside of the control area is referred to as a rear side. The security gates 111 and 112 include an outer lateral plate 131, an inner lateral plate 132, a front lateral cylinder 118, a rear lateral cylinder 117, top covers 113 and 114, base seats 115 and 116, and a controller 155. The outer lateral plate 131 includes a conductive metal material, which may be a single metal plate or a plastic plate together with a metal plate, so as to provide a shielding effect and reduce leaky wave of an electromagnetic wave. The inner lateral plate 132 is made of a non-metal material, so that an RFID antenna transmits and receives the electromagnetic wave, and reads the RFID tag, in which the non-metal material includes plastic, wood, cloth, paper, ceramic or glass. Photoelectric sensors 151 and 152 are disposed on the inner lateral plate 132, so as to detect times of persons passing through the security gate, and make statistical analysis on the use. The base seats 115 and 116 enable the security gates 111 and 112 to be fixed on the floor. The front lateral cylinder 118 and the rear lateral cylinder 117 provide structural strength for the security gates 111 and 112 to stand stably. The top covers 113 and 114 wrap upper sides of the security gates 111 and 112, and are disposed with a prompt device (not shown) and human body sensors 153 and 154 respectively. The controller 155 is used to control the photoelectric sensors 151 and 152, the human body sensors 153 and 154, and the prompt device (not shown).

An antenna shelf holder 133 and antenna direction adjusting bases 134 and 135 are disposed inside the security gates 111 and 112, so as to fix the position of the antennas 127 and 128 and adjust an antenna angle. The antenna direction adjusting bases 134 and 135 need to be a movable design in such a special mounting environment (that is, a small area or having multiple reflecting metal materials), so as to conveniently adjust the antenna angle; otherwise, a fixed angle may be designed to reduce the cost. If large deflection angles of the antennas 127 and 128 are required, the outer lateral plate 131 and the inner lateral plate 132 may be designed to be an arc shape, so that a larger space exists inside the gate plate for the deflection of the antennas 127 and 128. If omni-directional antennas 125 and 126 are too close to the metal, especially, the outer lateral plate 131, a reading rate for the RFID tag is affected, and an interval therebetween is generally more than 2 centimeters, so as to reduce the effect on the metal plate. The antenna 128 close to the front lateral cylinder 118 adopts the omni-directional antennas 125 and 126, so as to detect in a wide angle and a close distance, so that a detection range in the library is controlled within 2 meters from the security gate, thereby avoiding leaky wave of the electromagnetic wave to the library internally. The antenna 127 close to the rear lateral cylinder 117 adopts directional antennas 121, 122, 123, and 124, and a normal of the antenna is deflected towards the outside of the library, so as to provide a strong detection function and avoid leaky wave of the electromagnetic wave to the library internally. As for the case that the book or reference material is grasped, carried under the arm or attached to the body, according to height distribution of the users, an adult is mainly to carry the book between 80 cm and 150 cm in height, so enough directional antennas 121, 122, 123 and 134 need to be mounted, so as to improve the reading rate. The number of the antennas to be used and the mounting height are designed according to action and height of the user. The omni-directional antenna and the directional antenna are used at the same time, which can provide a wide detection angle, avoid leaky wave of the electromagnetic wave to the library internally, and strengthen the detection of the case that the book or reference material is grasped, carried under the arm or attached to the body, so as to achieve an effective and security management effect on the book or reference material. The RFID reader antennas 121, 122, 123, 124, 125 and 126 may be directly electrically connected to an RFID reader (not shown) so as to be integrated together, or may be electrically connected to the RFID reader through an RF coaxial cable. If the RFID reader is directly electrically connected to the RFID reader antennas 121, 122, 123, 124, 125 and 126, the RFID reader is also disposed inside the security gates 111 and 112; and if the connection thereof is implemented through the RF coaxial cable, the RFID reader may be disposed inside or outside the security gates 111 and 112 according to a design condition.

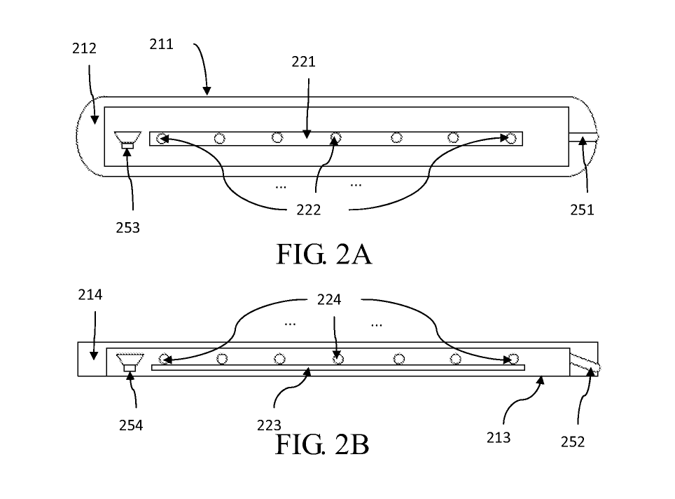

FIG. 2A and FIG. 2B are respectively a schematic top view and a schematic side view of a top cover of an RFID book management security gate according to the present invention. Top covers 211 and 213 of the security gates need to adopt a light transmissive material due to built-in prompt light devices 222 and 224, and the material includes plastic, glass, cloth or paper. Human body sensors 251 and 252 are disposed at a front side of housing 212 and 214 on the security gates, and a disposition angle thereof is designed according to a person detection range. The human body sensors 251 and 252 enable the RFID reader to detect at a high speed when a person is close to the security gates within a certain distance. When nobody is around, the RFID reader is enabled to detect at a low speed, thereby reducing power consumption, and achieving an energy-saving and carbon-reduction effect. Prompt light base seats 221 and 223 are disposed inside the top covers 211 and 213 of the security gates, and multiple prompt lights 222 and 224 are disposed thereon. When the RFID book management security gate detects that a security code of the RFID tag on the book or reference material is in a un-borrowed state, the prompt lights 222 and 224 are activated, so as to remind the user to transact the normal borrowing procedure, and remind the librarians to handle the situation. Audio devices 253 and 254 are also disposed inside the top covers 211 and 213 of the security gates. When the RFID book management security gate detects that a security code of the RFID tag on the book or reference material is in a un-borrowed state, the audio devices 253 and 254 are activated, so as to remind the user to transact the normal borrowing procedure, and remind the librarians to handle the situation. When it is detected that the security code is in a un-borrowed state, the prompt lights 222 and 224, and the audio devices 253 and 254 need to be activated at the same time, or be individually activated, which may be designed according to management rules.

The audio/video multimedia applicable to the present invention includes an optical disk, a videotape, an audiotape, or a memory card, in which the optical disk includes a Compact Disk (CD), a Video Compact Disk (VCD), a Digital Video Disk (DVD), a Laser Disk (LD), a Compact Disk Read Only Memory (CD-ROM), and other derived products. The book applicable to the present invention includes a book, a picture album, a document, a file or an archive. The RFID book management security gate of the present invention may exchange file with a library automatic system on line or perform an off-line operation, which is designed according to the management rules. The place applicable to the present invention includes a place having books and reference materials and having a file management function, such as a library, a reading room, an audio/video studio, or archives.

To sum up, the devices, methods, related structural features and embodiments of the present invention are disclosed in detail in the above, which can fully show a progress of the present invention in terms of the objectives and effects, have a utilization value in the industry, and moreover, are not applied in the prior art. According to the spirit of the patent law, the present invention completely conforms to the essential conditions of a invention patent.

To sum up, the above descriptions are merely preferred embodiments of the present invention, but are not intended to limit the present invention. Any modification, equivalent replacement, or improvement made without departing from the spirit and principle of the present invention should fall within the scope of the present invention.

What is claimed is:

1. A Radio Frequency Identification (RFID) book management security gate, applicable to a security gate for RFID book management operation and a book or reference material with an RFID technique, comprising:
a security gate;
at least one RFID tag, wherein an internal memory of the RFID tag stores a unique ID (UID) and a security code, and the RFID tag is attached to the book or reference material, so as to identify the book or reference material, and a borrowing and returning state thereof;
at least one RFID reader omni-directional antenna, disposed inside the security gate, and used to sense the RFID tag on the book or reference material and transmit a signal to an RFID reader;
at least one RFID reader directional antenna, disposed inside the security gate, and used to sense the RFID tag on the book or reference material and transmit a signal to the RFID reader;
at least one sensor, disposed on the security gate, and used to detect persons passing through the security gate, so as to perform management operation of the security gate; and
at least one prompt device, disposed on the security gate, and used to prompt that a book or reference material without a borrowing procedure is carried out of the security gate, so as to facilitate management.

2. The RFID book management security gate according to claim 1, wherein the RFID reader omni-directional antenna is one of a dipole antenna, a dipole array antenna, a shelf antenna and a chip antenna.

3. The RFID book management security gate according to claim 1, wherein the RFID reader directional antenna is one of a micro strip antenna, a patch antenna, a circular polarization antenna, a duplex polarization antenna, a linear polarization antenna, a linear polarization array antenna, a slot antenna, and a fractal antenna.

4. The RFID book management security gate according to claim 1, wherein the RFID tag is an Ultra High Frequency (UHF) RFID tag.

5. The RFID book management security gate according to claim 1, wherein the RFID reader antenna is electrically connected to a built-in RFID reader, or is externally connected to an RFID reader through an RF coaxial cable, so as to read and write the RFID tag, and the book or reference material is a book, a document or an audio/video multimedia.

6. The RFID book management security gate according to claim 1, wherein the security gate basically comprises an outer lateral plate, an inner lateral plate, a front lateral cylinder, a rear lateral cylinder, a top cover, a base seat, and a controller.

7. The RFID book management security gate according to claim 6, wherein the outer lateral plate comprises a conductive metal material, so as to provide a shielding effect and reduce leaky wave of an electromagnetic wave.

8. The RFID book management security gate according to claim 6, wherein the inner lateral plate is made of a non-metal material, so that the RFID antenna transmits and receives the electromagnetic wave, and reads the RFID tag, and the non-metal material comprises plastic, wood, paper, ceramic or glass.

9. The RFID book management security gate according to claim 6, wherein the controller is used to control the sensor and the prompt device.

10. The RFID book management security gate according to claim 1, wherein the sensor is a human body sensor, and used to detect a case that nobody is around the security gate, thereby reducing detection times of the RFID reader and then achieving an energy-saving and carbon-reduction effect.

11. The RFID book management security gate according to claim 1, wherein the sensor is a photoelectric sensor, and used to detect on the number of persons passing through the security gate, and make statistical analysis on the use.

12. The RFID book management security gate according to claim 1, wherein the prompt device is an audio device, and used to generate a warning sound, so as to remind a user to transact a borrowing procedure for the un-borrowed book or reference material, and remind librarians to handle the situation.

13. The RFID book management security gate according to claim 1, wherein the prompt device is a light device, and used to generate warning light, so as to remind a user to transact a borrowing procedure for the un-borrowed book or reference material, and remind librarians to handle the situation.
